(19) United States
(12) Patent Application Publication
(10) Pub. No.: US 2024/0364643 A1
(43) Pub. Date: Oct. 31, 2024

(54) TECHNOLOGIES FOR PROCESSING PACKETS ON A NETWORK INTERFACE CONTROLLER WITH HIGH-BANDWIDTH MEMORY CHIPLETS

(71) Applicant: Intel Corporation, Santa Clara, CA (US)

(72) Inventors: Sandeep K. Jain, Portland, OR (US); Akhilesh Thyagaturu, Tempe, AZ (US); Joshua B. Fryman, Corvallis, OR (US); Poornima Lalwaney, San Diego, CA (US); Vinodh Gopal, Westborough, MA (US); Brian Paul Johnson, Forest Grove, OR (US)

(73) Assignee: Intel Corporation, Santa Clara, CA (US)

(21) Appl. No.: 18/141,154

(22) Filed: Apr. 28, 2023

(51) Int. Cl. H04L 49/90; H04L 47/32; H04L 49/118

(52) U.S. Cl. CPC H04L 49/9068; H04L 47/32; H04L 49/118

(57) ABSTRACT

Techniques for processing packets on a network interface controller (NIC) with memory chiplets are disclosed. In an illustrative embodiment, a NIC includes a disaggregated memory with several high-bandwidth memory chiplets spread out in various locations on the NIC. The disaggregated nature of the memory can improve latency, throughput, and scalability as well as improve thermal performance by distributing heat generation to different locations on the NIC. In use, ports of the NIC can be configured to identify packets associated with certain flows and direct those packets to queues on the NIC. Direct memory access circuitry can copy the packets from queues on the NIC to queues on the system memory. This chain of copying packets from the port to the system memory creates a kind of virtual circuit, delivering packets directly to applications with low latency.

### BACKGROUND

Smart network interface controllers (NICs) are widely used to enhance the performance of network devices, particularly in a data center environment. Traditionally, network devices have used software-based packet processing, which involves the host CPU receiving and processing every packet. This approach results in high CPU utilization and latency, which can lead to poor system performance. To overcome this limitation, smart NICs were introduced, which can perform packet processing functions directly on the NIC hardware. This approach offloads the packet processing from the host CPU, thereby reducing the latency and improving the overall system performance.

### BRIEF DESCRIPTION OF THE DRAWINGS

FIG. 1 is a simplified block diagram of at least one embodiment of a system with compute devices connected by a network.

FIG. 2 is a simplified block diagram of at least one embodiment of a compute device of the system of FIG. 1.

FIG. 3 is a simplified block diagram of at least one embodiment of a network interface controller (NIC) of the compute device of FIG. 2.

FIG. 4 is a cross-sectional view of one embodiment of the NIC of the compute device of FIG. 2.

FIG. 5 is a simplified block diagram of at least one embodiment of a NIC of the compute device of FIG. 2.

FIG. 6 is a simplified block diagram of at least one embodiment of a NIC of the compute device of FIG. 2.

FIG. 7 is a simplified block diagram of at least one embodiment of a NIC of the compute device of FIG. 2.

FIG. 8 is a simplified block flow chart of at least one embodiment of a method for configuring a network interface controller to process packets.

FIG. 9 is a simplified block flow chart of at least one embodiment of a method for receiving packets by a network interface controller.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

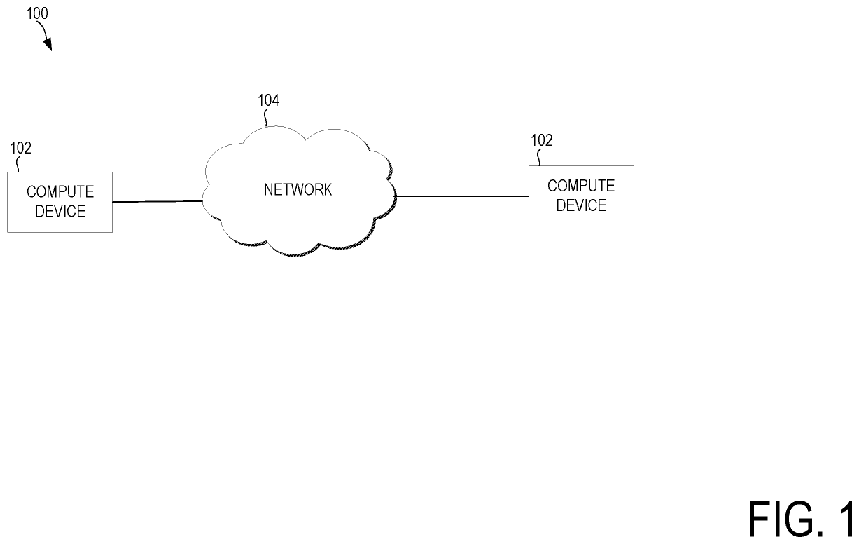

Referring now to FIG. 1, an illustrative system 100 includes one or more compute devices 102 connected by a network 106. In the illustrative embodiment, a compute device 102 may receive a packet over the network 104, such as from another compute device 102. As discussed in more detail below, the compute device 102 may include a smart network interface controller (NIC). The illustrative NIC may be configured to recognize packets from certain flows and direct those packets to queues in memory of the NIC. The NIC may also have DMA circuitry to automatically copy packets for a flow from the queue on the NIC to main memory, where an application can access them. In this manner, packets can be sent with low-latency directly to memory accessible by an application, creating a virtual circuit between the application and the NIC. Additional features of the compute device and NIC and some of the advantages those features allow are described in more detail below.

In the illustrative embodiment, the compute devices 102 and the network 104 are within a datacenter. For example, the compute devices 102 may be sleds in a rack of a datacenter, and the network 104 may be embodied as cables, routers, switches, etc., that connect racks in a datacenter. In one simplified embodiment, the system 100 includes two compute devices 102, as shown. Of course, in other embodiments, the system 100 may include any suitable number of compute devices 102, such as a million or more compute devices 102 for a large data center. The system 100 may include any suitable data center, such as an edge network, a cloud data center, an edge data center, a micro data center, a multi-access edge computing (MEC) environment, etc. Additionally or alternatively, in some embodiments, one or both of the compute devices 102 may be outside of a data center, such as compute devices 102 that form part of or connect to an edge network, a cellular network, a home network, a business network, a satellite network, etc.

In the illustrative embodiment, the compute devices 102 may be any suitable device that can communicate over a network 104, such as a server computer, a rack computer, a desktop computer, a laptop, a mobile device, a cell phone, a router, a switch, etc.

As used herein, a packet refers to a message received at a NIC over a network. A packet may refer to a frame, a datagram, an internet protocol (IP) packet, a transmission control protocol (TCP) packet, and/or the like.

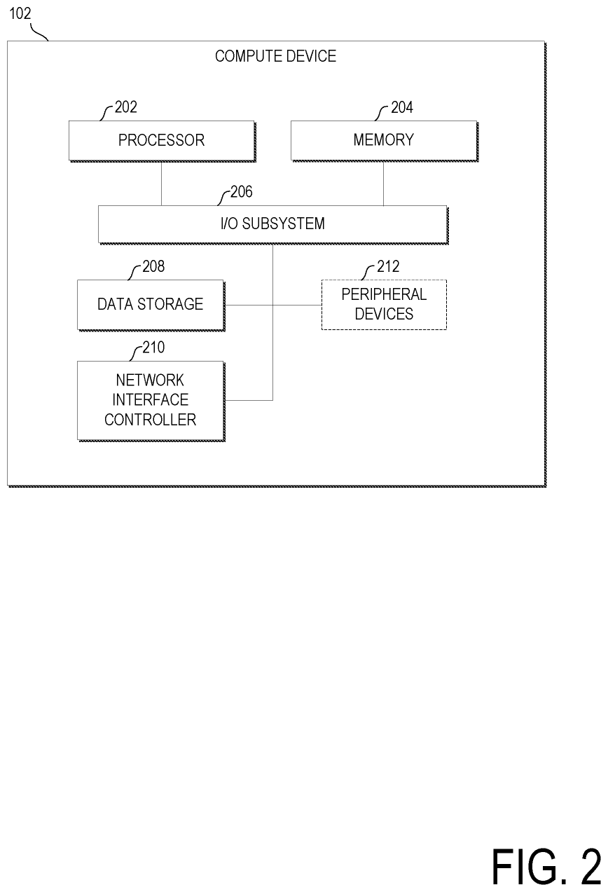

Referring now to FIG. 2, a simplified block diagram of a compute device 102 is shown. The compute device 102 may be embodied as any type of compute device. For example, the compute device 102 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, a distributed computing system, and/or any other computing device. The illustrative compute device 102 includes a processor 202, a memory 204, an input/output (I/O) subsystem 206, data storage 208, a network interface controller (NIC) 210, and one or more optional peripheral devices 212. In some embodiments, one or more of the illustrative components of the compute device 102 may be incorporated in, or otherwise form a portion of, another component. For example, the memory 204, or portions thereof, may be incorporated in the processor 202 in some embodiments.

In some embodiments, the compute device 102 may be located in a data center with other compute devices 102, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, an infrastructure processing unit (IPU), a data processing unit (DPU), an xPU, or other processor or processing/controlling circuit. The processor 202 may include any suitable number of cores, such as any number from 1-1,024.

The memory 204 may be embodied as any type of volatile or non-volatile memory or data storage capable of performing the functions described herein. In operation, the memory 204 may store various data and software used during operation of the compute device 102, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the compute device 102. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the compute device 102 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 206 may form a portion of a system-on-a-chip (SoC) and be incorporated, along with the processor 202, the memory 204, the NIC 210, and other components of the compute device 102 on a single integrated circuit chip.

The data storage 208 may be embodied as any type of device or devices configured for the short-term or long-term storage of data. For example, the data storage 208 may include any one or more memory devices and circuits, memory cards, hard disk drives, solid-state drives, or other data storage devices.

The NIC 210 may be embodied as any type of interface capable of interfacing the compute device 102 with other compute devices, such as over one or more wired or wireless connections. In some embodiments, the NIC 210 may be capable of interfacing with any appropriate cable type, such as an electrical cable or an optical cable. The NIC 210 may be configured to use any one or more communication technology and associated protocols (e.g., Ethernet, Bluetooth®, Wi-Fi®, WiMAX, near field communication (NFC), 4G, 5G, etc.). The NIC 210 may be located on silicon separate from the processor 202, or the NIC 210 may be included in a multi-chip package with the processor 202, or even on the same die as the processor 202. The NIC 210 may be embodied as one or more add-in-boards, daughtercards, network interface cards, controller chips, chipsets, specialized components such as a field-programmable gate array (FPGA) or application-specific integrated circuit (ASIC), or other devices that may be used by the compute device 202 to connect with another compute device. In some embodiments, NIC 210 may be embodied as part of a system-on-a-chip (SoC) that includes one or more processors, or included on a multichip package that also contains one or more processors. In some embodiments, the NIC 210 may include a network accelerator complex (NAC), which may include a local processor, local memory, and/or other circuitry on the NIC 210. In such embodiments, the NAC may be capable of performing one or more of the functions of the processor 202 described herein. Additionally or alternatively, in such embodiments, the NAC of the NIC 210 may be integrated into one or more components of the compute device 102 at the board level, socket level, chip level, and/or other levels.

In some embodiments, the compute device 102 may include other or additional components, such as those commonly found in a compute device. For example, the compute device 102 may also have peripheral devices 212, such as a keyboard, a mouse, a speaker, a microphone, a display, a camera, a battery, an external storage device, etc.

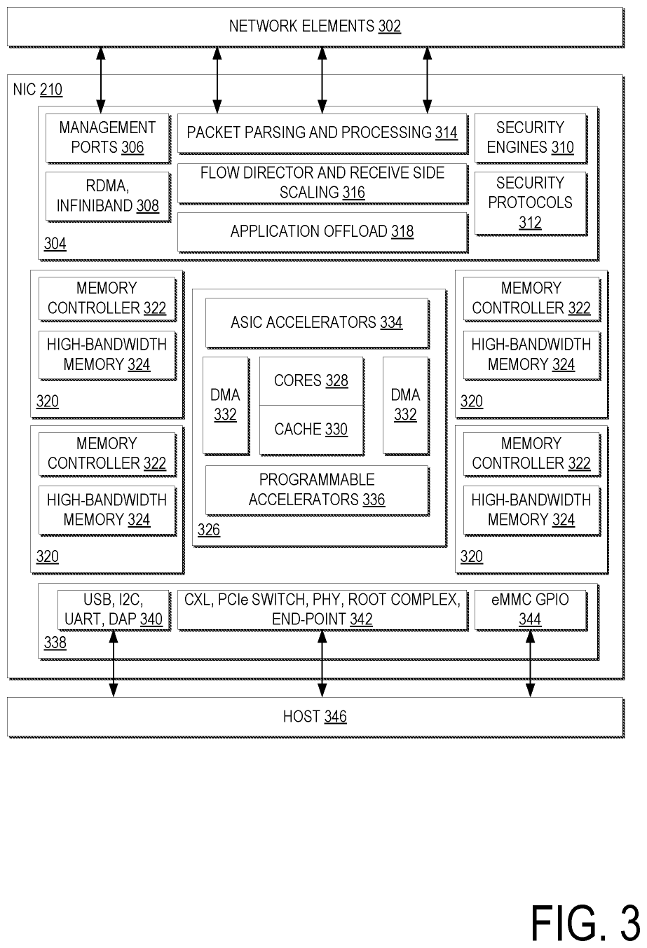

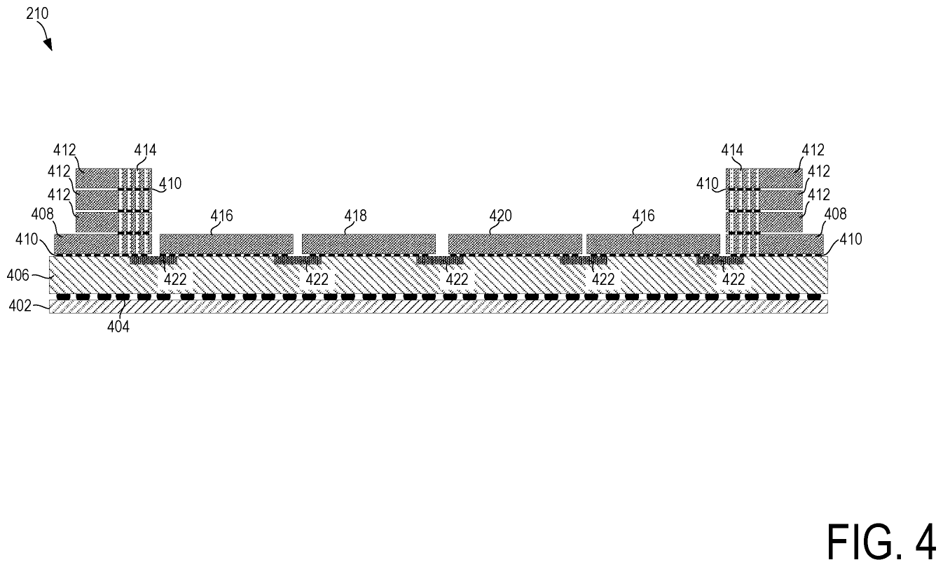

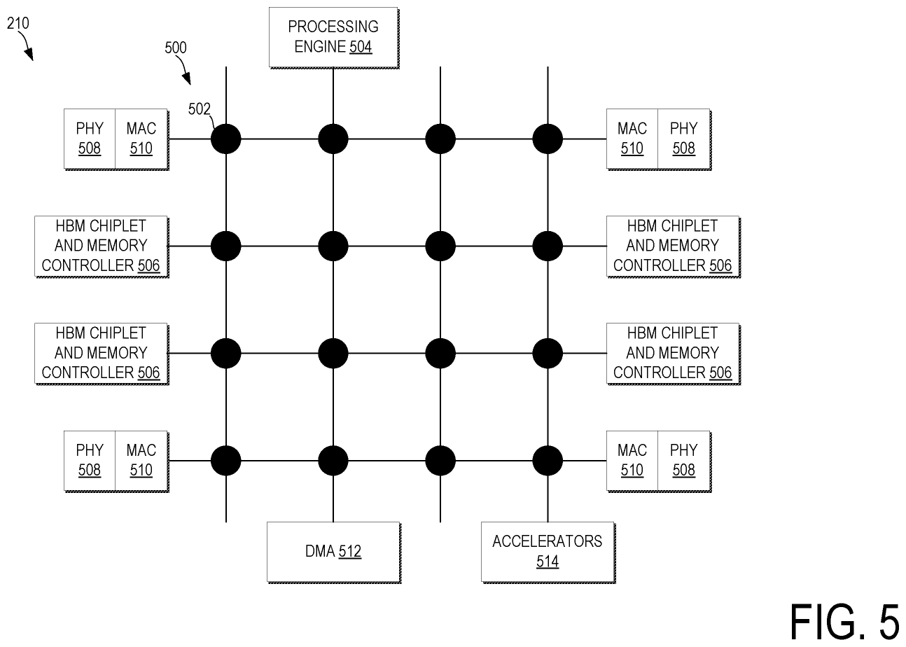

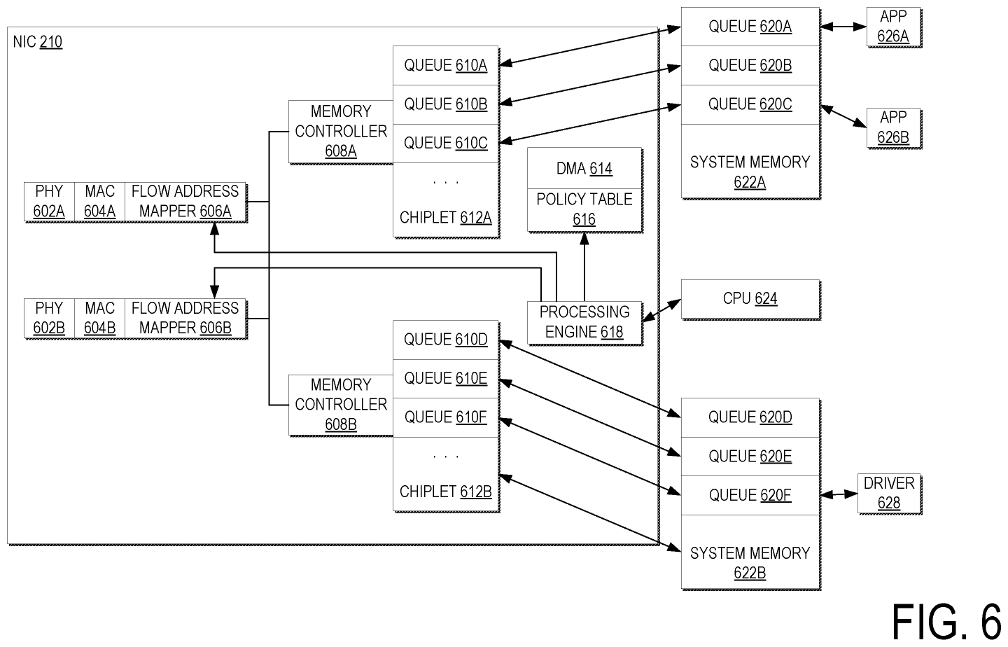

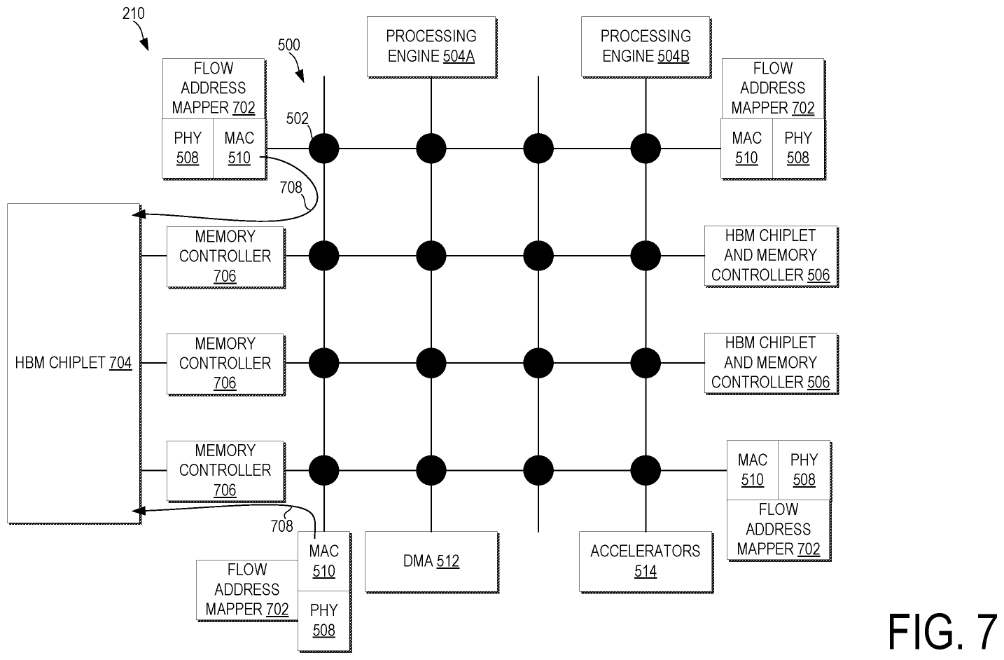

The NIC 210 is described in more detail in regard to FIGS. 3-7 below. It should be appreciated that the various depictions of the NIC 210, such as the NIC 210 shown in FIG. 3, the NIC 210 shown in FIG. 4, the NIC 210 shown in FIG. 5, the NIC 210 shown in FIG. 6, and the NIC 210 shown in FIG. 7 may refer to different depictions of the same or similar embodiments, with a different emphasis on different aspects or representations of the NIC 210. For example, the NIC 210 shown in FIG. 3 depicts some of the hardware and function of the NIC 210, FIG. 4 depicts the physical arrangement and interconnections between some of the components of the NIC 210, FIG. 5 depicts how different components of the NIC 210 may be connected by a NoC 500, FIG. 6 depicts some of the functions of some components and the control and/or data flow between various components, and FIG. 7 shows another depiction of how different components of the NIC 210 may be connected by a NoC 500. Various embodiments of the NIC 210 may include some or all of the components, features, interconnects shown in FIGS. 3-7 and described herein and/or any suitable combination thereof. The various blocks and functions on the NIC 210 shown and described below may be embodied as hardware, software, firmware, or a combination thereof. For example, in some embodiments, some or all of the blocks or various combinations of the blocks shown in FIGS. 3-7 may be embodied as one or more chiplets mounted together on one or more substrates.

Referring now to FIG. 3, a simplified block diagram showing one illustrative embodiment of a NIC 210 is shown connected to one or more network elements 302 and a host 346. The network elements 302 may be, e.g., one or more Ethernet cables, one or more optical cables, one or more antennas, etc. The network elements 302 may interface with one or more network interface components 304. Management ports 306 may receive physical signals from the network elements 302. RDMA, InfiniBand 308 may be configured to perform remote direct memory access, such as by using an InfiniBand connection. Security engines 310 may perform encryption and decryption of packets sent and received by the NIC 210. The security protocols 312 may provide configuration for the security engines 310 and/or enforce certain security requirements. Packet parsing and processing 314 is configured to parse and process packets. Flow director and receive side scaling 316 facilitate flow director and receive side scaling to direct packets, such as Ethernet packets, to a desired core of the processor 202. Application offload 318 is configured to perform some application functions on the NIC 210 to speed up or reduce latency of certain application functions.

The illustrative NIC 210 includes several memory elements 320. Each memory element 320 includes a memory controller 322 and one or more high-bandwidth memory dies 324. The memory elements 320 may be distributed in different locations around the NIC 210, which may reduce latency from various components to the nearest memory element 320 as well as spread thermal dissipation across the NIC 210, allowing for better, easier, and/or more efficient thermal management. In some embodiments, the NIC 210 may include other memory devices in addition to or in place of high-bandwidth memory dies 324, such as double data rate 5 synchronous dynamic random-access memory (DDR5 SDRAM) or DDR4 SDRAM, which may be compatible with one or more JEDEC standards such as JEDEC JESD79-4C published in January 2020, JEDEC JESD79-5 published in July 2020, or JEDEC JESD79-5B published in August 2022. In some embodiments, some or all of the memory elements 320 may be external to or otherwise separate from the NIC 210.

The illustrative NIC 210 includes one or more processing elements 326. The NIC 210 may include one or more processing cores 328 with attached cache 330, such as level 2 and/or level 3 cache. The NIC 210 may include DMA circuitry 332 to perform direct memory access operations on the main memory 204. The NIC 210 may include one or more application-specific integrated circuit (ASIC) accelerators 334 to perform certain tasks. Additionally or alternatively, the NIC 210 may include one or more programmable accelerators 336, such as a field-programmable gate array (FPGA) or graphics processing unit (GPU).

The NIC 210 may include any suitable host I/O element 338, such as a universal serial bus (USB), inter-integrated circuit (I2C), universal asynchronous receiver/transmitter (UART), directory access protocol (DAP) circuitry 340. Additionally or alternatively, the NIC 210 may include compute express link (CXL), peripheral component interconnect express (PCIe), physical layer, root complex, end-point circuitry 342. Additionally or alternatively, the NIC 210 may include embedded multimedia card (eMMC), general purpose input/output (GPIO) circuitry 344. The host I/O element 338 may interface with one or more components on the host 346, such as through the I/O subsystem 206.

Referring now to FIG. 4, in one embodiment, a cross-sectional side view of a network interface controller 210 is shown, showing some of the components of the NIC 210. The NIC 210 includes a circuit board 402 that is connected to a package substrate 406 using one or more solder balls 404. The NIC 210 includes various chiplets, such as one or more high-bandwidth memory base dies 408, one or more memory controllers 416, one or more compute chiplets 418, and one or more general purpose chiplets 420. The various chiplets may be mounted on the substrate using microbumps 410. In the illustrative embodiment, high-bandwidth memory dies 412 are stacked on the base die 408. Through-silicon vias 414 may be used to provide interconnects through the high-bandwidth memory dies 412 and/or through others of the various chiplets. Interconnections between the various dies/chiplets can be provided by the package substrate 406, one or more silicon interposers, one or more silicon bridges 422 embedded in the package substrate (such as Intel® embedded multi-die interconnect bridges (EMIBs), Intel® modular die-fabric interconnect (MDFI), and/or universal chiplet interconnect express (UCIE)), or combinations thereof.

The circuit board 402 may be embodied as a circuit board made from ceramic, glass, and/or organic-based materials with fiberglass and resin, such as FR-4. Additionally or alternatively, the circuit board 402 may be embodied as or include any other suitable material, such as silicon, silicon oxide, glass, etc. The circuit board 402 may include traces, vias, etc., connecting various components mounted on the circuit board 402. The circuit board 402 may have any suitable dimension, such as a length and/or width of 5-50 millimeters, and a thickness of 0.1-3 millimeters. The substate 406 may be embodied as a circuit board made from ceramic, glass, and/or organic-based materials with fiberglass and resin, such as FR-4. Additionally or alternatively, the substate 406 may be embodied as or include any other suitable material, such as silicon, silicon oxide, glass, etc. The substate 406 may include traces, vias, etc., connecting various components mounted on the substate 406, such as the memory base dies 408, the memory controller 416, etc. The substate 406 may have any suitable dimension, such as a length and/or width of 5-50 millimeters, and a thickness of 0.1-3 millimeters.

Each base die 408 may have any suitable number of memory dies 412 stacked on top of it, such as 1-16 dies. The base die 408 may include buffer circuitry and test logic. In some embodiments, the base die 408 may be omitted. In the illustrative embodiment, the base dies 408, memory dies 412, and/or memory controllers 416 are compatible with a high-bandwidth memory (HBM) standard adopted by Joint Electron Device Engineering Council (JEDEC), such as High Bandwidth Memory (HBM) DRAM standard published in document JESD235D in March 2021, High Bandwidth Memory (HBM3) DRAM standard published in document JESD238A in January 2023, and/or any other suitable past or future HBM standard adopted by JEDEC. The stack of memory dies 412 may have any suitable number of pins, such as 128-16,384. The stack of memory dies 412 may have any suitable capacity and bandwidth, such as a capacity of 1-128 gigabytes and a per-pin bandwidth of 0.25-4 gigabits.

Referring now to FIG. 5, in one embodiment, a diagram of a network-on-a-chip (NoC) 500 that the NIC 210 may implement is depicted along with various components of the NIC 210 connected by the NoC 500. The NoC 500 may include several NoC routers 502 that can route messages within the NoC 500 and to and from various components connected to the NoC 500.

A processing engine 504 may be connected to the NoC 500. The processing engine 504 may configure other components of the NIC 210, such as the MAC 510 and DMA circuitry 512, as discussed in more detail below in regard to FIG. 6. One or more HBM chiplets and memory controllers 506 are connected to illustrative NoC 500. Physical layer circuitry 508 and media access control layer circuitry 510 are connected to the NoC 500 as well. DMA circuitry 512 is connected to the NoC 500 and may directly write to the main memory 204. One or more accelerators 514, such as an ASIC, FPGA, and/or GPU, may be connected to the NoC 500.

Referring now to FIG. 6, a simplified block diagram of one embodiment of the NIC 210 and interfaces with other components of the compute device 102 are shown. The illustrative NIC 210 includes physical layer circuitry (PHY) 602A and PHY 602B, which interface with a physical connection such as an Ethernet cable. The PHY 602A and PHY 602B are coupled to a medium access control layer circuitry (MAC) 604A and MAC 604B, respectively. Each MAC 604 may use a flow address mapper 606 to control how some packets that arrive at the MAC 604 are processed. In particular, a flow address mapper 606 may include one or more entries in a table, such as entries in Table 1 shown below. Each entry in the table includes flow-specific information that can be used to identify whether a particular packet is part of a particular flow. If it is, the packet may be sent directly to a queue 610 established in a memory chiplet 612. If it is not, the packet may be processed in a different manner, such as by using a hash function to assign the packet to a general (as opposed to flow-specific) receive queue (not shown in FIG. 6). Such a packet may be processed with use of techniques such as receive side scaling (RSS) and/or flow director. A packet may be matched to a particular flow by matching some or all of the information in the “Flow Specific Information” section of Table 1. In some embodiments, different types of information may be used to identify a flow, such as parameters associated with a 5G network flow, user association, application information, VLAN tagging, MAC address, and/or the like. In some embodiments, the flow address mapper 606 may determine a type of memory to send a packet to based on the flow of the packet, such as a relatively high-bandwidth HBM chiplet 612 or a relatively low-bandwidth SDRAM module. In some embodiments, some or all of the memory corresponding to the memory addresses may be external to or otherwise separate from the NIC 210.

TABLE 1
Table for Flow-to-Memory Mapping

| Flow Specific Information | | | | | Memory Information | |
|---|---|---|---|---|---|---|
| | Destination | Source | Destination | | Start | End |
| Source IP | IP | Port | Port | IP Type | Address | Address |
| 192.168.1.1 | 192.168.2.1 | 5000 | 5000 | UDP (0) | 0x000F | 0x00EF |
| 192.168.3.1 | 192.168.4.1 | 6000 | 6000 | TCP (1) | 0x00FF | 0x0FFF |
| — | — | — | — | — | — | — |

In some embodiments, the flow address mapper 606 may be part of the MAC 604, such as by forming part of the MAC circuitry on a die. Additionally or alternatively, in some embodiments, the flow address mapper 606 may be a different die from the MAC 604 or different circuitry on the same die as the MAC 604. The MAC 604 may use the flow address mapper 606 to determine where to send a packet or the MAC 604 may pass the packet to the flow address mapper 606, and the flow address mapper 606 may pass the packet to the next destination. In some embodiments, the flow address mapper may be embodied as circuitry with an input and an output to receive and output data, respectively. The flow address mapper 606 may include processing circuitry to perform the function described herein.

The illustrative NIC 210 includes disaggregated memory in the form of several memory chiplets 612, such as memory chiplet 612A and memory chiplet 612B. The memory chiplets 612 may be similar to or the same as the base die 408 and memory dies 412. As such, each memory chiplet 612 may refer to a stack or other grouping of two or more dies. In the illustrative embodiment, each memory chiplet 612 has a corresponding memory controller 608. Each MAC 604 is connected to each memory controller 608, such as through the NoC 500.

The DMA circuitry 614 is configured to perform direct memory access operations to write data to and read data from the system memory 622, which may be the system memory 204. In some embodiments, the DMA circuitry 614 writes to queues, such as queues 620A-620F, established in the system memory 622. In some embodiments, the queues 620A-620F may be application device queues (ADQs). The DMA circuitry 614 may access a policy table 616 to determine how to perform memory operations. For example, the policy table 616 may indicate a size, priority, policy, QoS specific requirements, etc., to factor in while performing DMA operations. One example embodiment of a table in the policy table 616 that the DMA circuitry 614 may access is shown in Table 2.

TABLE 2
Table for Dedicated DMA Channel Configuration

| Queue Start | Queue End | Destination Address | | | | QoS |
|---|---|---|---|---|---|---|
| Address | Address | (System Memory) | Size | Priority | Policy | Specific |
| 0x000F | 0x00EF | 0x003F | 100 | 10 | Round | Best |
| | | | MB | | robin | effort |
| 0x00FF | 0x0FFF | 0x0CCF | 1 | 1 | Dedicated | Deadline |
| | | | GB | | | |
| — | — | — | — | — | — | — |

In use, a CPU 624, which may be the processor 202, launches applications, such as application 626A and application 626B, as well as other operations such as a driver 628. The applications 626A, 626B, CPU 624 or other component may create one or more queues 620 in system memory 622. For example, in an illustrative embodiment, queues 620A-620C may be created in system memory 622A, and queues 620D-620F may be created in system memory 622B.

The CPU 624 may determine network applications associated with the queues 620, such as network applications for the applications 626A, 626B. The CPU 624 may create a socket for a network flow for the network applications and determine a quality of service (QoS) policy corresponding to the network flow. The CPU 624 may determine a recommended configuration for the NIC 210 based on the QoS policy, such as parameters for a queue in the NIC 210 and/or parameters for direct memory access (DMA) circuitry 614 in the NIC 210.

The CPU 624 can send flow information, queue information, and the recommended configuration to the processing engine 618 on the NIC 210. The processing engine 618 may be embodied as any suitable circuitry, such as software or firmware running on a core 328 of the NIC 210. In some embodiments, the processing engine 618 may be stand-alone circuitry dedicated to performing the functions described herein. The processing engine 618 can evaluate available resources and configure other components of the NIC 210 accordingly. The processing engine 618 may establish queues 610A-610F in the NIC 210 memory corresponding to queues 620A-620F in the system memory 204. The processing engine 618 may create one or more entries in a flow-to-memory mapping table, such as Table 1 above, for the network flows. The processing engine 618 may send table entries to the flow address mappers 606 so the flow address mappers 606 can identify packets associated with the network flow and direct the packets to the corresponding queue. The processing engine 618 can also create one or more entries in a table for dedicated DMA channel configuration, such as Table 2 above, for controlling how the DMA circuitry 614 performs DMA operations on the queues 610A-F.

In use, a PHY 602 receives a packet, and passes it to the corresponding MAC 604. The MAC 604 consults the flow address mapper 606 to determine if there is an entry in a flow-to-memory mapping table for the flow corresponding to the packet. To do so, the flow address mapper 606 performs a comparison between parameters of the packet and parameters in the table entries, such as source and destination IP addresses, source and destination ports, etc. If there is a match, the MAC 604 sends the packet to the memory controller 608 for the memory address in the flow-to-memory mapping table. The memory controller 608 then adds the packet to the corresponding queue 610. In some cases, the MAC 604 may perform

The DMA circuitry 614 may then copy entries from the queue 610 to the queue 620. The DMA circuitry 614 may perform DMA operations based on the entries in the policy table 616. Processes on the CPU 624 such as applications 626A, 626B may then access the packet in the corresponding queue 620. The applications 626A, 626B may access the queues 620 in any suitable manner, such as using queue polling, queue monitoring, busy-poll, functions such as UMONITOR, UMWAIT, etc.

Additionally or alternatively, the NIC 210 may improve the process of sending packets. For example, the queues 610, 620 may be send queues, and the DMA circuitry 614 may be configured to automatically copy packets to be sent from the queue 620 in system memory 204 to the queue 610 in the memory chiplet 612 in the NIC 210. The NIC 210 can then send the packets from the queue 610 based on a scheduling algorithm, which may take into account flow QoS requirements.

The hardware configuration and data flow shown in FIG. 6 provides several advantages. The disaggregated nature of the memory can improve latency, throughput, and scalability. As the number of ports and bandwidth of the NIC 210 increases, additional memory chiplets 612 and memory controllers 608 can be added, without constraints of a monolithic memory stack. The NoC 500 described in FIG. 5 combined with the disaggregated nature of the memory chiplets 612 can reduce or eliminate bottlenecks. The use of separate memory chiplets 612 can also facilitate or simplify memory isolation for virtualization environments.

As described above, as packets for a flow are received, they can be directly copied to a queue on the NIC and then directly copies to a queue on the main memory 204 associated with the flow, creating a kind of virtual circuit from the port to the application. This approach can provide critical isolation to containers, virtual machines, and applications. This approach can configure the NIC 210 hardware at high granularity and enumerate it as separate hardware, such as single-root input/output virtualization (SR-IOV), and assign it to particular containers/virtual machines. The hardware of the NIC 210 can be assigned dynamically on-demand by adding more processing resources, memory allocation, and other resources of the NIC 210.

In use, ports of the NIC can be configured to identify packets associated with certain flows and direct those packets to queues on the NIC. Direct memory access circuitry can copy the packets from queues on the NIC to queues on the system memory. This chain of copying packets from the port to the system memory creates a kind of virtual circuit, delivering packets directly to applications with low-latency.

Another advantage the approach described above delivers is the automatic isolation of so-called elephant and mice flows. As packets are immediately sent to a queue specified for a particular flow, the impact of an elephant flow or even a denial-of-service attack can be reduced or eliminated.

Although some of the advantages described above result from a disaggregated memory on the NIC 210, it should be appreciated that flow address mappers 606 to map packets associated with an identified flow directly to a queue 610 can also be used with a monolithic, centralized NIC 210 memory.

Referring now to FIG. 7, a diagram of the NIC 210 with a network-on-a-chip (NoC) 500 is shown. The components of the NIC 210 shown in FIG. 7 may be similar to or the same as the components of the NIC 210 shown in FIG. 5, a description of which will not be repeated in the interest of clarity. FIG. 7 also depicts flow address mappers 702 connected to each MAC 510. When a MAC 510 receives a packet, it may access the corresponding flow address mapper 702 determine where to pass the packet to. The MAC 510 may pass the packet to a nearby memory controller 706 along a path 708 through the NoC 500. In some embodiments, as shown in FIG. 7, several memory controllers 706 may be connected to a single set of high-bandwidth memory chiplets 704. Such an approach may provide a larger fan-out for DMA transactions, reducing overall I/O saturation and increasing the efficiency for end-to-end flow.

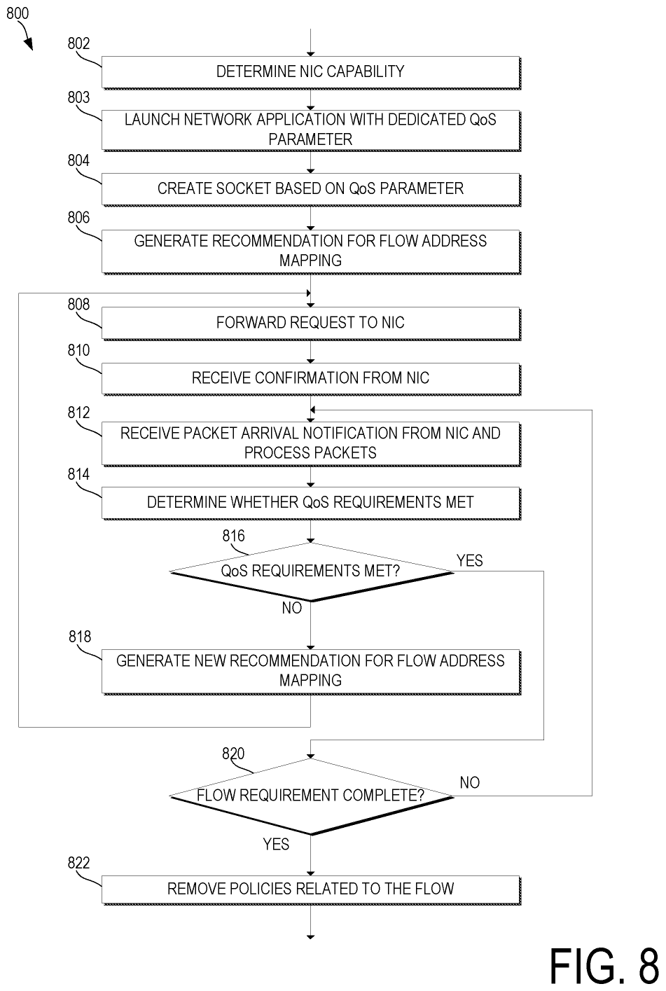

Referring now to FIG. 8, in use, the compute device 102 may execute a method 800 for configuring the NIC 210 to process packets. The method 800 may be executed by any suitable component or combination of components of the compute device 102, including hardware, software, firmware, an operating system, etc. For example, some or all of the method 800 may be performed by the NIC 210 and/or the processor 202. In the illustrative embodiment, the method 800 describes the method from the perspective of operations performed by application or other process on the processor 202. In some embodiments, any suitable aspect of the method 800 may be performed by another component, such as the core 328, the accelerators 334, 336, the application offload 318, etc.

The method 800 begins in block 802, in which the compute device 102 determines the capability of the NIC 210. In the illustrative embodiment, an operating system or other component of the compute device 102 may query the NIC 210 for its capabilities, and the NIC 210 may indicate the capabilities in a response. For example, the NIC 210 may indicate that it has flow address mappers 606 that can identify packets associated with a flow and send them directly to a queue associated with the flow.

In block 803, the compute device 102 launches a network application with one or more dedicated QoS parameters, such as a requirement for a network flow to have a certain bandwidth, latency, jitter, etc. The network application may be any suitable user-level or system-level application that requires communication over a network. In block 804, the compute device 102 creates a socket based on the QoS parameter.

In block 806, the compute device 102 or component thereof (such as an operating system) generates a recommendation for flow address mapping. For example, the compute device 102 may recommend a certain memory allocation, queue formation, DMA allocation, bandwidth allocation, a desired memory type (for example, HBM or DDR SDRAM) for packets for a particular flow, etc. As the NIC 210 may not have resources to fulfill every requirement for every request, the NIC 210 may determine how to configure components on the NIC 210 as best it can. In some embodiments, the compute device 102 or component thereof (such as an operating system) may program some or all of the NIC 210, such as the flow address mappers 606. In some embodiments, the compute device 102 may using machine-learning-based techniques, such as a reinforcement machine-learning algorithm to generate the flow address mapping recommendations.

In block 808, the compute device 102 forwards the request to the NIC 210. The request may include flow parameter information, such as source and destination IP address, source and destination ports, the protocol used, and/or the like. The particular parameters sent to identify a flow may depend on the particular protocol used. The request sent to the NIC 210 also includes QoS information, mapping recommendations, and other flow parameter and configuration information. In some cases, such as after a determination that a QoS requirement is not met in block 816 described below, the request sent to the NIC 210 may include revised flow address mapping and other parameter recommendations to improve or adjust the QoS achieved. In block 810, the compute device 102 receives confirmation of the request from the NIC 210.

In block 812, the compute device 102 receives packet arrival notification from the NIC 210 and processes the packets. The compute device 102 may process packets arrived in any suitable manner, such as by using receive side scaling, flow director, interrupts, polling, etc.

In block 814, the compute device 102 determines whether QoS and/or other performance requirements or desires are being met. If they are not, the method 800 proceeds to block 818, in which the compute device 102 generates a new flow address mapping recommendation based on the monitored performance, available resources, QoS requirements, etc. The method 800 then loops backs to block 808 to send the revised request to the NIC 210. The closed-loop control of the flow allows for feedback between the NIC 210 and the processor 202 and/or application to facilitate performance improvement or optimization.

Referring back to block 816, if QoS requirements are met, the method 800 jumps to block 820. In block 820, if the flow requirement is complete, such as if the flow is complete or the QoS requirements are complete, the method 800 proceeds to block 822, in which the compute device 102 removes policies from the NIC 210 related to the flow, such as by removing entries in a table for the flow-to-memory mapping and removing entries a table for the dedicated DMA channel configuration. If the flow is not complete, the method 800 loops back to block 812 to continue receiving packets and monitoring QoS.

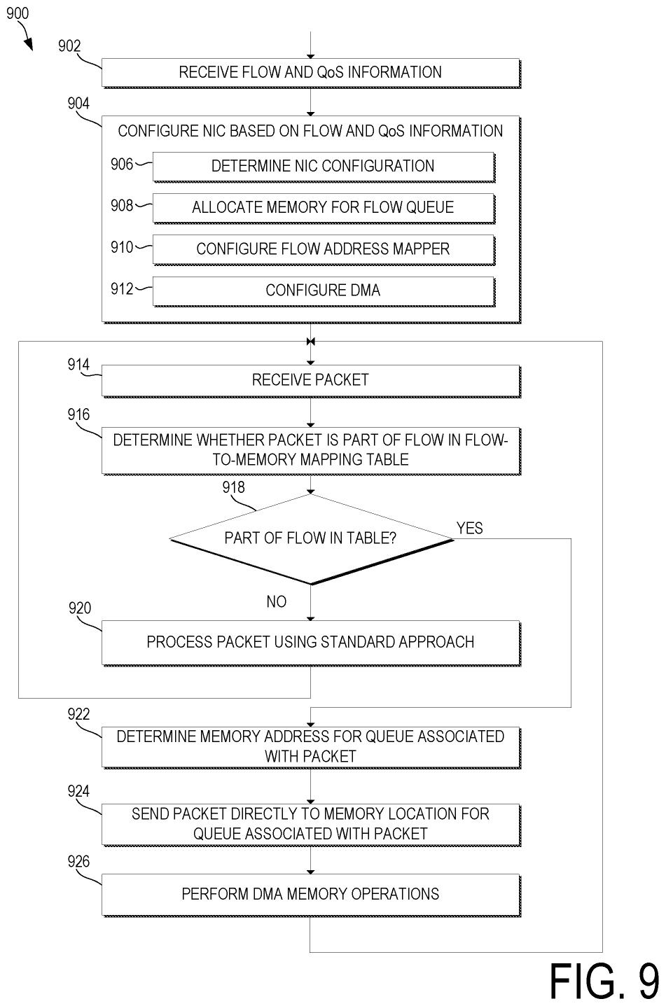

Referring now to FIG. 9, in use, the compute device 102 may execute a method 900 for receiving packets by the NIC 210. In the illustrative embodiment, the method 900 may be executed by any suitable component or combination of components of the NIC 210, including hardware, software, firmware, etc., such as the processing engine 618, the DMA circuitry 614, the flow address mapper 606, etc. In some embodiments, any suitable aspect of the method 900 may be performed by another component of the compute device 102, such as the processor 202. For example, in some embodiments, the processer 202 may determine how to allocate all resources on the NIC 210 rather than the processing engine 618.

The method 900 begins in block 902, in which the NIC 210 receives flow and QoS information. The flow information may include flow parameters, such as source and destination IP address, source and destination ports, the protocol used, and/or the like. The particular parameters sent to identify a flow may depend on the particular protocol used. The QoS parameters may include information such as a requirement for a network flow to have a certain bandwidth, latency, etc. The information sent to the NIC 210 also includes a recommendation for flow address mapping, memory locations for queues in the system memory 204, and other configuration recommendations. For example, the compute device 102 may recommend to the NIC 210 a certain memory allocation, queue formation, DMA allocation, bandwidth allocation, etc.

In block 904, the NIC 210 configures itself based on the flow and QoS information. In block 906, the NIC 210 determines a configuration based on available resources such as available memory, available DMA circuitry 614, etc. As the NIC 210 may not have resources to fulfill every requirement, the NIC 210 may determine how to configure components on the NIC 210 as best it can. The NIC 210 may receive a maximum rate that an application or processor 202 can process packets from a particular flow at, and the NIC 210 may configure itself to stay below that level, such as by dropping packets. Packets may be dropped by the DMA circuitry 614 by, for example, removing packets from the queue when too many packets are being received to be processed by the processor 102/application and/or when too many packets are being received to send to the system memory 204. Additionally or alternatively, packets may be dropped directly at the MAC 604, such as by configuring the flow address mapper 606 to temporarily drop packets associated with a flow.

In block 908, the NIC 210 allocates space for a queue 610 in a memory chiplet 612. The NIC 210 may allocate the queue in a memory chiplet 612 near a PHY port 602 where the packets for the flow are expected in order to reduce routing in the NoC 500 to transfer the packets to the memory chiplet 612.

In block 910, the NIC 210 configures one or more flow address mappers 606 to identify packets associated with the flow. To do so, the NIC 210 may write an entry in a flow-to-memory mapping table, such as Table 1 shown above.

In block 912, the NIC 210 configures one or more DMAs 614 to perform memory operations associated with the flow, such as transferring packets from the queue 610 on the NIC 210 associated with the flow to the queue 620 on the main memory 204 associated with the flow. The DMA circuitry 614 may be configured as a dedicated circuit for the flow, as a round-robin, etc., and may be configured with QoS parameters such as best effort, deadline, etc. In the illustrative embodiment, the DMA configuration information is stored in a policy table 616.

In block 914, the NIC 210 receives a packet. In block 916, a MAC 604 determines whether a packet is part of a flow with an entry in a flow-to-memory mapping table, such as by suing a flow address mapper 606.

In block 918, if the packet is not part of a flow in the table, the method 900 proceeds to block 920, in which the NIC 210 processes the packet using a standard approach, such as by using a hash algorithm to assign the packet to a general receive queue for processing. If the packet is part of a flow in the table, the method 900 proceeds to block 922 to determine a memory address for a queue associated with the packet. In the illustrative embodiment, the memory address is in the entry associated with the flow in the flow-to-memory mapping table that is stored in the flow address mapper 606.

In block 924, the MAC 604 sends the received packet directly to the memory location for the queue associated with the packet. The corresponding memory controller 608 receives the packet and stores it in the correct location in the queue 610.

In block 926, the DMA circuitry 614 performs one or more DMA memory operations. The DMA circuitry 614 may perform memory operations based on the configured policy and QoS operations. Although presented in the flow chart as occurring after the packet is sent to the memory location, it should be appreciated that the DMA circuitry 614 may operate without explicitly being triggered by receipt of packets. The DMA circuitry 614 may, for example, copy packets from the queue 610 in the memory chiplet 612 of the NIC 210 to the corresponding queue 620 in the system memory 204.

### Examples

Illustrative examples of the technologies disclosed herein are provided below. An embodiment of the technologies may include any one or more, and any combination of, the examples described below.

Example 1 includes a network interface controller comprising one or more memory devices; a memory controller coupled to the one or more memory devices; flow address mapper circuitry to receive a memory address of a queue, wherein the memory address corresponds to a memory location at the one or more memory devices; and receive one or more flow parameters for a flow associated with the queue; physical (PHY) layer circuitry to receive a packet; and medium access control (MAC) layer circuitry communicatively coupled to the PHY layer circuitry, the MAC layer circuitry to receive the packet from the PHY layer circuitry, wherein the flow address mapper circuitry is further to perform a comparison between one or more parameters of the packet and the one or more flow parameters for the flow, wherein the MAC layer circuitry is further to pass the packet to the memory controller to be stored in the queue based on the comparison.

Example 2 includes the subject matter of Example 1, and wherein the one or more memory devices include a plurality of memory chiplets, the network interface controller further comprising a plurality of memory controllers including the memory controller, individual ones of the plurality of memory controllers to control a corresponding one of the plurality of memory chiplets.

Example 3 includes the subject matter of any of Examples 1 and 2, and wherein to perform the comparison between one or more parameters of the packet and the one or more flow parameters for the flow comprises to determine whether the packet is part of the flow.

Example 4 includes the subject matter of any of Examples 1-3, and wherein to determine whether the packet is part of the flow comprises to determine whether individual ones of the one or more parameters of the packet match individual corresponding flow parameters of the one or more flow parameters.

Example 5 includes the subject matter of any of Examples 1-4, and further including direct memory access circuitry to copy the packet from the queue to a corresponding queue main memory.

Example 6 includes the subject matter of any of Examples 1-5, and further including a processing engine to receive one or more QoS parameters for the flow; and configure the flow address mapper circuitry based on the one or more QoS parameters.

Example 7 includes the subject matter of any of Examples 1-6, and further including direct memory access circuitry to drop the packet based on the one or more QoS parameters.

Example 8 includes the subject matter of any of Examples 1-7, and wherein the one or more QoS parameters indicate a maximum packet rate, wherein to drop the packet comprises to drop the packet based on the maximum packet rate.

Example 9 includes the subject matter of any of Examples 1-8, and wherein the PHY layer circuitry is further to receive a second packet and pass the second packet from the PHY layer circuitry to the MAC layer circuitry, wherein the flow address mapper circuitry is further to perform a comparison between one or more parameters of the second packet and the one or more flow parameters for the flow, wherein the MAC layer circuitry is further to drop the second packet based on the comparison between the one or more parameters of the second packet and the one or more flow parameters for the flow and based on the one or more QoS parameters for the flow.

Example 10 includes the subject matter of any of Examples 1-9, and further including a processing engine to receive one or more recommended network interface controller configuration parameters for the flow; and determine a configuration for the network interface controller based on available resources of the network interface controller and on the one or more recommended network interface controller configuration parameters for the flow.

Example 11 includes the subject matter of any of Examples 1-10, and wherein the one or more parameters of the packet comprises a source internet protocol (IP) address, a destination IP address, a source port, and a destination port.

Example 12 includes a method comprising receiving, by flow address mapper circuitry of a network interface controller (NIC), a memory address of a queue, wherein the memory address corresponds to a memory location at one or more memory devices of the NIC; receiving, by the flow address mapper circuitry, one or more flow parameters for a flow associated with the queue; receiving, at physical (PHY) layer circuitry of the NIC, a packet; passing the packet from the PHY layer circuitry to medium access control (MAC) layer circuitry of the NIC; performing, by the flow address mapper circuitry, a comparison between one or more parameters of the packet and the one or more flow parameters for the flow; and passing the packet from the MAC layer circuitry to a memory controller of the NIC to be stored in the queue based on the comparison, wherein the memory controller is coupled to the one or more memory devices.

Example 13 includes the subject matter of Example 12, and wherein the one or more memory devices include a plurality of memory chiplets, the NIC comprising a plurality of memory controllers including the memory controller, individual ones of the plurality of memory controllers to control a corresponding one of the plurality of memory chiplets.

Example 14 includes the subject matter of any of Examples 12 and 13, and wherein performing the comparison between one or more parameters of the packet and the one or more flow parameters for the flow comprises determining whether the packet is part of the flow.

Example 15 includes the subject matter of any of Examples 12-14, and wherein determining whether the packet is part of the flow comprises determining whether individual ones of the one or more parameters of the packet match individual corresponding flow parameters of the one or more flow parameters.

Example 16 includes the subject matter of any of Examples 12-15, and further including copying, by direct memory access circuitry, the packet from the queue to a corresponding queue main memory.

Example 17 includes the subject matter of any of Examples 12-16, and further including receiving, by the NIC, one or more QoS parameters for the flow; and configuring, by the NIC, the flow address mapper circuitry based on the one or more QoS parameters.

Example 18 includes the subject matter of any of Examples 12-17, and further including dropping, by direct memory access circuitry, the packet based on the one or more QoS parameters.

Example 19 includes the subject matter of any of Examples 12-18, and wherein the one or more QoS parameters indicate a maximum packet rate, wherein dropping the packet comprises dropping the packet based on the maximum packet rate.

Example 20 includes the subject matter of any of Examples 12-19, and further including receiving, at the PHY layer circuitry, a second packet; passing the second packet from the PHY layer circuitry to the MAC layer circuitry; performing, by the flow address mapper circuitry, a comparison between one or more parameters of the second packet and the one or more flow parameters for the flow; and dropping, by the MAC layer circuitry, the second packet based on the comparison between the one or more parameters of the second packet and the one or more flow parameters for the flow and based on the one or more QoS parameters for the flow.

Example 21 includes the subject matter of any of Examples 12-20, and further including receiving, by the NIC, one or more recommended NIC configuration parameters for the flow; and determining, by the NIC, a configuration for the NIC based on available resources of the NIC and on the one or more recommended NIC configuration parameters for the flow.

Example 22 includes the subject matter of any of Examples 12-21, and wherein the one or more parameters of the packet comprises a source internet protocol (IP) address, a destination IP address, a source port, and a destination port.

Example 23 includes a network interface controller comprising means for receiving a memory address of a queue, wherein the memory address corresponds to a memory location at one or more memory devices of the network interface controller (NIC); means for receiving one or more flow parameters for a flow associated with the queue; means for receiving, at physical (PHY) layer circuitry of the NIC, a packet; means for passing the packet from the PHY layer circuitry to medium access control (MAC) layer circuitry of the NIC; means for performing a comparison between one or more parameters of the packet and the one or more flow parameters for the flow; and means for passing the packet from the MAC layer circuitry to a memory controller of the NIC to be stored in the queue based on the comparison, wherein the memory controller is coupled to the one or more memory devices.

Example 24 includes the subject matter of Example 23, and wherein the one or more memory devices include a plurality of memory chiplets, the network interface controller further comprising a plurality of memory controllers including the memory controller, individual ones of the plurality of memory controllers to control a corresponding one of the plurality of memory chiplets.

Example 25 includes the subject matter of any of Examples 23 and 24, and wherein the means for performing the comparison between one or more parameters of the packet and the one or more flow parameters for the flow comprises means for determining whether the packet is part of the flow.

Example 26 includes the subject matter of any of Examples 23-25, and wherein the means for determining whether the packet is part of the flow comprises means for determining whether individual ones of the one or more parameters of the packet match individual corresponding flow parameters of the one or more flow parameters.

Example 27 includes the subject matter of any of Examples 23-26, and further including means for copying, by direct memory access circuitry, the packet from the queue to a corresponding queue main memory.

Example 28 includes the subject matter of any of Examples 23-27, and further including means for receiving, by the NIC, one or more QoS parameters for the flow; and means for configuring, by the NIC, flow address mapper circuitry based on the one or more QoS parameters.

Example 29 includes the subject matter of any of Examples 23-28, and further including means for dropping, by direct memory access circuitry, the packet based on the one or more QoS parameters.

Example 30 includes the subject matter of any of Examples 23-29, and wherein the one or more QoS parameters indicate a maximum packet rate, wherein the means for dropping the packet comprises means for dropping the packet based on the maximum packet rate.

Example 31 includes the subject matter of any of Examples 23-30, and further including means for receiving, at the PHY layer circuitry, a second packet; means for passing the second packet from the PHY layer circuitry to the MAC layer circuitry; means for performing, by flow address mapper circuitry, a comparison between one or more parameters of the second packet and the one or more flow parameters for the flow; and means for dropping, by the MAC layer circuitry, the second packet based on the comparison between the one or more parameters of the second packet and the one or more flow parameters for the flow and based on the one or more QoS parameters for the flow.

Example 32 includes the subject matter of any of Examples 23-31, and further including means for receiving, by the NIC, one or more recommended NIC configuration parameters for the flow; and means for determining, by the NIC, a configuration for the NIC based on available resources of the NIC and on the one or more recommended NIC configuration parameters for the flow.

Example 33 includes the subject matter of any of Examples 23-32, and wherein the one or more parameters of the packet comprises a source internet protocol (IP) address, a destination IP address, a source port, and a destination port.

Example 34 includes an apparatus of a network interface controller (NIC) comprising an input and an output; and processing circuitry coupled to the input and to the output, the processing circuitry to receive, at the input, a memory address of a queue, the memory address corresponding to a memory location at one or more memory circuitries of the NIC; receive, at the input, one or more flow parameters for a flow associated with the queue; perform a comparison between one or more parameters of a packet of medium access control (MAC) layer circuitry of the NIC and the one or more flow parameters; and send information based on the comparison to the MAC circuitry to cause the MAC circuitry to send the packet to be stored in the queue based on the information.

Example 35 includes the subject matter of Example 34, and wherein the MAC layer circuitry comprises the processing circuitry.

Example 36 includes the subject matter of any of Examples 34 and 35, and wherein the one or more memory devices include a plurality of memory chiplets, the network interface controller further comprising a plurality of memory controllers including the memory controller, individual ones of the plurality of memory controllers to control a corresponding one of the plurality of memory chiplets.

Example 37 includes the subject matter of any of Examples 34-36, and wherein to perform the comparison between one or more parameters of the packet and the one or more flow parameters for the flow comprises to determine whether the packet is part of the flow.

Example 38 includes the subject matter of any of Examples 34-37, and wherein to determine whether the packet is part of the flow comprises to determine whether individual ones of the one or more parameters of the packet match individual corresponding flow parameters of the one or more flow parameters.

Example 39 includes the subject matter of any of Examples 34-38, and further including direct memory access circuitry to copy the packet from the queue to a corresponding queue main memory.

Example 40 includes the subject matter of any of Examples 34-39, and further including a processing engine to receive one or more QoS parameters for the flow; and configure the flow address mapper circuitry based on the one or more QoS parameters.

Example 41 includes the subject matter of any of Examples 34-40, and further including direct memory access circuitry to drop the packet based on the one or more QoS parameters.

Example 42 includes the subject matter of any of Examples 34-41, and wherein the one or more QoS parameters indicate a maximum packet rate, wherein to drop the packet comprises to drop the packet based on the maximum packet rate.

Example 43 includes the subject matter of any of Examples 34-42, and wherein the PHY layer circuitry is further to receive a second packet and pass the second packet from the PHY layer circuitry to the MAC layer circuitry, wherein the flow address mapper circuitry is further to perform a comparison between one or more parameters of the second packet and the one or more flow parameters for the flow, wherein the MAC layer circuitry is further to drop the second packet based on the comparison between the one or more parameters of the second packet and the one or more flow parameters for the flow and based on the one or more QoS parameters for the flow.

Example 44 includes the subject matter of any of Examples 34-43, and further including a processing engine to receive one or more recommended network interface controller configuration parameters for the flow; and determine a configuration for the network interface controller based on available resources of the network interface controller and on the one or more recommended network interface controller configuration parameters for the flow.

Example 45 includes the subject matter of any of Examples 34-44, and wherein the one or more parameters of the packet comprises a source internet protocol (IP) address, a destination IP address, a source port, and a destination port.

Example 46 includes one or more computer-readable media comprising a plurality of instructions stored thereon that, when executed, causes processing circuitry of a network interface controller (NIC) to receive a memory address of a queue, the memory address corresponding to a memory location at one or more memory circuitries of the NIC; receive one or more flow parameters for a flow associated with the queue; perform a comparison between one or more parameters of a packet of medium access control (MAC) layer circuitry of the NIC and the one or more flow parameters; and send information based on the comparison to the MAC circuitry to cause the MAC circuitry to send the packet to be stored in the queue based on the information.

Example 47 includes the subject matter of Example 46, and wherein the one or more memory devices include a plurality of memory chiplets, the network interface controller comprising a plurality of memory controllers including the memory controller, individual ones of the plurality of memory controllers to control a corresponding one of the plurality of memory chiplets.

Example 48 includes the subject matter of any of Examples 46 and 47, and wherein to perform the comparison between one or more parameters of the packet and the one or more flow parameters for the flow comprises to determine whether the packet is part of the flow.

Example 49 includes the subject matter of any of Examples 46-48, and wherein to determine whether the packet is part of the flow comprises to determine whether individual ones of the one or more parameters of the packet match individual corresponding flow parameters of the one or more flow parameters.

Example 50 includes the subject matter of any of Examples 46-49, and wherein the plurality of instructions further cause the processing circuitry to copy the packet from the queue to a corresponding queue main memory.

Example 51 includes the subject matter of any of Examples 46-50, and wherein the plurality of instructions further cause the processing circuitry to receive one or more QoS parameters for the flow; and configure the flow address mapper circuitry based on the one or more QoS parameters.

Example 52 includes the subject matter of any of Examples 46-51, and further including direct memory access circuitry to drop the packet based on the one or more QoS parameters.

Example 53 includes the subject matter of any of Examples 46-52, and wherein the one or more QoS parameters indicate a maximum packet rate, wherein to drop the packet comprises to drop the packet based on the maximum packet rate.

Example 54 includes the subject matter of any of Examples 46-53, and wherein the plurality of instructions further causes the compute device to receive a second packet and pass the second packet from the PHY layer circuitry to the MAC layer circuitry, wherein the plurality of instructions further causes the compute device to perform a comparison between one or more parameters of the second packet and the one or more flow parameters for the flow, wherein the plurality of instructions further causes the compute device to drop the second packet based on the comparison between the one or more parameters of the second packet and the one or more flow parameters for the flow and based on the one or more QoS parameters for the flow.

Example 55 includes the subject matter of any of Examples 46-54, and wherein the plurality of instructions further cause the processing circuitry to receive one or more recommended network interface controller configuration parameters for the flow; and determine a configuration for the network interface controller based on available resources of the network interface controller and on the one or more recommended network interface controller configuration parameters for the flow.

Example 56 includes the subject matter of any of Examples 46-55, and wherein the one or more parameters of the packet comprises a source internet protocol (IP) address, a destination IP address, a source port, and a destination port.

1. A network interface controller comprising:
one or more memory devices;
a memory controller coupled to the one or more memory devices;
flow address mapper circuitry to:
receive a memory address of a queue, wherein the memory address corresponds to a memory location at the one or more memory devices; and
receive one or more flow parameters for a flow associated with the queue;
physical (PHY) layer circuitry to receive a packet; and
medium access control (MAC) layer circuitry communicatively coupled to the PHY layer circuitry, the MAC layer circuitry to receive the packet from the PHY layer circuitry,
wherein the flow address mapper circuitry is further to perform a comparison between one or more parameters of the packet and the one or more flow parameters for the flow,
wherein the MAC layer circuitry is further to pass the packet to the memory controller to be stored in the queue based on the comparison.

2. The network interface controller of claim 1, wherein the one or more memory devices include a plurality of memory chiplets, the network interface controller further comprising a plurality of memory controllers including the memory controller, individual ones of the plurality of memory controllers to control a corresponding one of the plurality of memory chiplets.

3. The network interface controller of claim 1, wherein to perform the comparison between one or more parameters of the packet and the one or more flow parameters for the flow comprises to determine whether the packet is part of the flow.

4. The network interface controller of claim 3, wherein to determine whether the packet is part of the flow comprises to determine whether individual ones of the one or more parameters of the packet match individual corresponding flow parameters of the one or more flow parameters.

5. The network interface controller of claim 1, further comprising direct memory access circuitry to copy the packet from the queue to a corresponding queue main memory.

6. The network interface controller of claim 1, further comprising a processing engine to:
receive one or more QoS parameters for the flow; and
configure the flow address mapper circuitry based on the one or more QoS parameters.

7. The network interface controller of claim 6, further comprising direct memory access circuitry to drop the packet based on the one or more QoS parameters.

8. The network interface controller of claim 7, wherein the one or more QoS parameters indicate a maximum packet rate, wherein to drop the packet comprises to drop the packet based on the maximum packet rate.

9. The network interface controller of claim 6, wherein the PHY layer circuitry is further to receive a second packet and pass the second packet from the PHY layer circuitry to the MAC layer circuitry,
wherein the flow address mapper circuitry is further to perform a comparison between one or more parameters of the second packet and the one or more flow parameters for the flow,
wherein the MAC layer circuitry is further to drop the second packet based on the comparison between the one or more parameters of the second packet and the one or more flow parameters for the flow and based on the one or more QoS parameters for the flow.

10. The network interface controller of claim 1, further comprising a processing engine to:
receive one or more recommended network interface controller configuration parameters for the flow; and
determine a configuration for the network interface controller based on available resources of the network interface controller and on the one or more recommended network interface controller configuration parameters for the flow.

11. The network interface controller of claim 1, wherein the one or more parameters of the packet comprises a source internet protocol (IP) address, a destination IP address, a source port, and a destination port.

12. An apparatus of a network interface controller (NIC) comprising:
an input and an output; and
processing circuitry coupled to the input and to the output, the processing circuitry to:
receive, at the input, a memory address of a queue, the memory address corresponding to a memory location at one or more memory circuitries of the NIC;
receive, at the input, one or more flow parameters for a flow associated with the queue;
perform a comparison between one or more parameters of a packet of medium access control (MAC) layer circuitry of the NIC and the one or more flow parameters; and
send information based on the comparison to the MAC circuitry to cause the MAC circuitry to send the packet to be stored in the queue based on the information.

13. The apparatus of claim 12, wherein the MAC layer circuitry comprises the processing circuitry.

14. The apparatus of claim 12, wherein to perform the comparison between one or more parameters of the packet and the one or more flow parameters for the flow comprises to determine whether the packet is part of the flow.

15. The apparatus of claim 14, wherein to determine whether the packet is part of the flow comprises to determine whether individual ones of the one or more parameters of the packet match individual corresponding flow parameters of the one or more flow parameters.

16. The apparatus of claim 12, wherein the one or more parameters of the packet comprises a source internet protocol (IP) address, a destination IP address, a source port, and a destination port.

17. A network interface controller comprising:
means for receiving a memory address of a queue, wherein the memory address corresponds to a memory location at one or more memory devices of the network interface controller (NIC);
means for receiving one or more flow parameters for a flow associated with the queue;
means for receiving, at physical (PHY) layer circuitry of the NIC, a packet;
means for passing the packet from the PHY layer circuitry to medium access control (MAC) layer circuitry of the NIC;
means for performing a comparison between one or more parameters of the packet and the one or more flow parameters for the flow; and
means for passing the packet from the MAC layer circuitry to a memory controller of the NIC to be stored in the queue based on the comparison, wherein the memory controller is coupled to the one or more memory devices.

18. The network interface controller of claim 17, wherein the one or more memory devices include a plurality of memory chiplets, the network interface controller further comprising a plurality of memory controllers including the memory controller, individual ones of the plurality of memory controllers to control a corresponding one of the plurality of memory chiplets.

19. The network interface controller of claim 17, further comprising means for copying, by direct memory access circuitry, the packet from the queue to a corresponding queue main memory.

20. The network interface controller of claim 17, further comprising:
means for receiving, by the NIC, one or more recommended NIC configuration parameters for the flow; and
means for determining, by the NIC, a configuration for the NIC based on available resources of the NIC and on the one or more recommended NIC configuration parameters for the flow.
